(19) United States
(12) Patent Application Publication
(10) Pub. No.: US 2026/0269339 A1
(43) Pub. Date: Sep. 10, 2026

(54) METHOD AND STORAGE MEDIUM FOR CONTROLLING BATTERY POOL MANAGEMENT, APPARATUS FOR CONTROLLING BATTERY TRANSACTION SUPPORT

(71) Applicant: SK On Co., Ltd., Seoul (KR)

(72) Inventor: Young Jun CHOI, Daejeon (KR)

(21) Appl. No.: 19/561,533

(22) Filed: Mar. 10, 2026

(30) Foreign Application Priority Data
Mar. 10, 2025 (KR) 10-2025-0030370

(51) Int. Cl. H01M 10/42

(52) U.S. Cl. CPC H01M 10/4285

(57) ABSTRACT

A method for controlling battery pool management, according to an embodiment of the present disclosure, includes inputting a plurality of parameters for each of a plurality of batteries in a battery pool; receiving a battery request signal for the battery pool; classifying the plurality of batteries into a plurality of groups based on the plurality of parameters, with a classification criterion at or after a time at which the battery request signal is received; and outputting information of a group corresponding to the battery request signal, among the plurality of groups.

### CROSS-REFERENCE TO RELATED APPLICATION(S)

This patent document claims the priority and benefits of Korean Patent Application No. 10-2025-0030370 filed on Mar. 10, 2025, the disclosure of which is incorporated herein by reference in its entirety.

### TECHNICAL FIELD

The disclosure and implementations disclosed in this patent document generally relate to a method and storage medium for controlling battery pool management, and an apparatus for controlling battery transaction support.

### BACKGROUND

Batteries may be widely used not only in small electronic devices such as mobile phones and laptops, but also in medium and large-sized mechanical devices such as vehicles, and may be implemented as secondary batteries, which also have the advantage of being able to be charged and recharged. In addition, batteries may be widely used in other applications, different from vehicles, such as in mobility devices, energy storage systems (ESS), a distributed power generation system (e.g., solar power generation systems), and an uninterruptible power supply system (UPS).

As the demand for batteries increases and the usage range of batteries increases, a size of the battery trading market is gradually growing. As the size of the battery trading market increases, characteristics or models of batteries may gradually be diversified, and difficulty of matching (and/or required time) of characteristics/models between a battery consumer and a battery supplier may increase. Among batteries supplied by the battery supplier, batteries that do not meet the battery supplier for a long time may gradually deteriorate in performance and may eventually be discarded. The difficulty of matching (and/or time required for matching) characteristics/models between a battery consumer and a battery supplier may be lowered by battery classification.

### SUMMARY

A method and storage medium for controlling battery pool management, and an apparatus for controlling battery transaction support, according to an embodiment of the present disclosure, may improve classification accuracy/reliability of a plurality of batteries of a battery pool.

A method for controlling battery pool management, according to an embodiment of the present disclosure, includes inputting a plurality of parameters for each of a plurality of batteries in a battery pool; receiving a battery request signal for the battery pool; classifying the plurality of batteries into a plurality of groups based on the plurality of parameters, with a classification criterion at or after a time at which the battery request signal is received; and outputting information of a group corresponding to the battery request signal, among the plurality of groups.

For example, the inputting may include updating the plurality of parameters, as configurations of the plurality of batteries in the battery pool are changed.

For example, the receiving may include receiving a battery request signal before the updating the plurality of parameters, and receiving a battery request signal after the updating the plurality of parameters, the classifying may include classifying the plurality of batteries into a plurality of groups based on the plurality of parameters, with a classification criterion before the updating the plurality of parameters, and the classifying may include classifying the plurality of batteries into a plurality of groups based on the plurality of parameters, with a classification criterion after the updating the plurality of parameters.

For example, the classifying may include updating classification of the plurality of batteries into a plurality of groups, as configurations of the plurality of batteries in the battery pool are changed, optionally according to whether correlation between at least one of the classified groups is effectively changed.

For example, the classifying may include applying the plurality of parameters to a classification model, with a classification criterion at or after a time at which the battery request signal is received, and the classification model may include a support vector machine model.

For example, the classifying may include filtering by classifying some of the plurality of batteries into one of the plurality of groups, and classifying a remaining battery of the plurality of batteries into a remaining group of the plurality of groups based on the plurality of parameters, and the classifying may include applying the plurality of parameters to the support vector machine model for the filtering.

For example, the classifying may include applying the plurality of parameters to a classification model, with a classification criterion at or after a time at which the battery request signal is received, and the classification model may be configured to classify correlation between batteries of each of the plurality of groups to be higher than a reference.

For example, the plurality of parameters may include at least two of a standard parameter for a standard of the plurality of batteries, a quality parameter for quality of the plurality of batteries, a storage parameter for storage of the plurality of batteries, and a measurement parameter corresponding to a measurement result for the plurality of batteries.

For example, the plurality of batteries may include a new battery and a used battery.

For example, the receiving may include receiving the battery request signal including subject data of at least one among a plurality of battery requestors, and the outputting may include outputting information of a group corresponding to the subject data among the plurality of groups.

A storage medium according to an embodiment of the present disclosure may record at least one program including instructions for executing the method for controlling battery pool management.

An apparatus for controlling battery transaction support, according to an embodiment of the present disclosure, includes a controller inputting a plurality of parameters for each of a plurality of batteries in a battery pool, receiving a battery request signal for the battery pool, classifying the plurality of batteries into a plurality of groups based on the plurality of parameters, with a classification criterion at or after a time at which the battery request signal is received, and outputting information of a group corresponding to the battery request signal, among the plurality of groups, wherein the controller executes at least one of a first interface operation of inputting the plurality of parameters from at least one of a plurality of battery providers; a second interface operation of receiving the battery request signal from at least one of a plurality of battery requesters; or a third interface operation of outputting the information to at least one of the plurality of battery requestors.

For example, the controller may apply the plurality of parameters to a classification model, with a classification criterion at or after a time at which the battery request signal is received, and the classification model may include a support vector machine model.

For example, the controller may update the plurality of parameters, as at least one of the plurality of battery providers provides a battery to the battery pool.

For example, the plurality of parameters may include at least two of a standard parameter for a standard of the plurality of batteries, a quality parameter for quality of the plurality of batteries, a storage parameter for storage of the plurality of batteries, and a measurement parameter corresponding to a measurement result for the plurality of batteries, and the plurality of batteries may include a new battery and a used battery.

### BRIEF DESCRIPTION OF DRAWINGS

Certain aspects, features, and advantages of the present disclosure may be illustrated by the following detailed description with reference to the accompanying drawings.

FIG. 1 is a block diagram illustrating a method and storage medium for controlling battery pool management, and an apparatus for controlling battery transaction support, according to an embodiment of the present disclosure.

FIGS. 2, 3, and 4 are flowcharts illustrating a method and storage medium for controlling battery pool management, and an apparatus for controlling battery transaction support, according to an embodiment of the present disclosure.

FIGS. 5 and 6 are graphs illustrating that a method and storage medium for controlling battery pool management, and an apparatus for controlling battery transaction support, according to an embodiment of the present disclosure, classify a plurality of batteries into a plurality of groups by applying a plurality of parameters to a classification model (e.g., a support vector machine model).

FIG. 7 is a graph illustrating that a method and storage medium for controlling battery pool management, and an apparatus for controlling battery transaction support, according to an embodiment of the present disclosure, a plurality of parameters are updated and classification of a plurality of batteries into a plurality of groups is updated.

### DETAILED DESCRIPTION

Specific matters of other embodiments may be included in the detailed description and drawings.

The advantages and features of the present disclosure and methods for achieving them will become clear with reference to embodiments described below in detail with the accompanying drawings. However, the present disclosure is not limited to embodiments disclosed below and may be implemented in various different forms, and the present embodiments may be provided only to ensure that the present disclosure is complete and to fully inform those skilled in the art to which the present disclosure pertains, and the present disclosure may be only defined by the scope of the claims. Throughout the specification, the same reference numerals may refer to the same components.

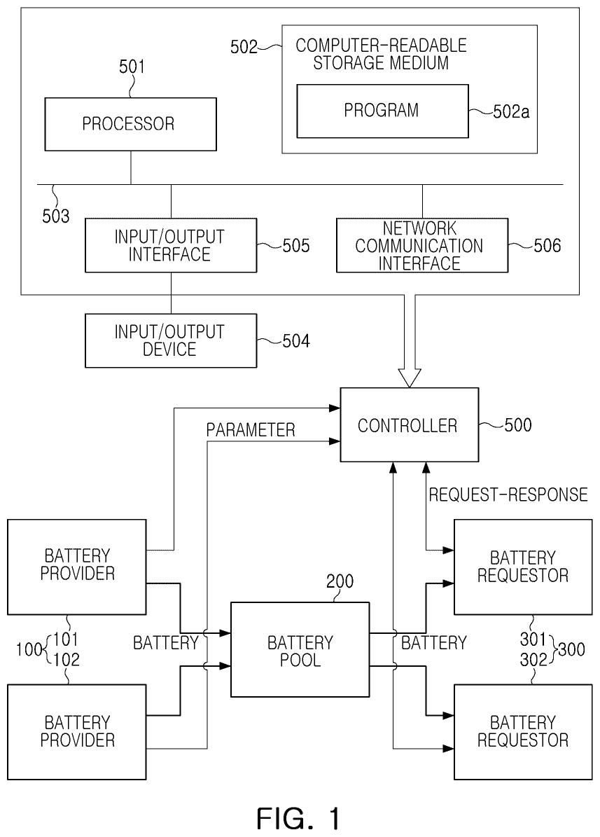

Referring to FIG. 1, each of a plurality of battery providers 100 may provide a battery to a battery pool 200, and each of a plurality of battery requestors 300 may obtain the battery from the battery pool 200.

For example, the battery may include at least one of a battery cell, a battery module, or a battery pack. The battery pack may have a structure in which a plurality of battery modules are disposed, and the battery module may have a structure in which a plurality of battery cells are disposed. For example, each of the plurality of battery cells may include a case accommodating an electrode assembly and an electrolyte, and a lead tab electrically connected to the electrode assembly to protrude from at least one side of the case. The electrode assembly may be configured to stack a positive electrode plate and a negative electrode plate such that wider surfaces thereof face each other, with a separator interposed therebetween. The separator may be configured to prevent electrical short-circuit between the positive electrode plate and the negative electrode plate and to generate flow of ions. For example, the separator may include a porous polymer film or a porous nonwoven fabric. Each of the plurality of battery cells may be implemented as one of a pouch type, a cylindrical type, or a prismatic type, but is not limited thereto.

For example, a plurality of batteries of the battery pool 200 may be expressed as stock batteries, and a subject managing the battery pool 200 may be at least one of the plurality of battery providers 100. For example, at least one of the plurality of battery providers 100 may directly provide some of new batteries produced by a production facility to at least one of the plurality of battery requesters 300, and a remaining battery of the new batteries may be immediately provided to the battery pool 200.

Depending on a design, the plurality of battery providers 100 may be configured as a single battery provider, a plurality of battery providers that may be the same type (e.g., a battery producer), or a plurality of battery providers that may be different from each other. Depending on a design, the plurality of battery requestors 300 may be configured as a single battery requestor, a plurality of battery requestors that may be the same type (e.g., a vehicle manufacturer), or a plurality of battery requestors that may be different from each other.

For example, when the plurality of battery providers 100 are different from each other, a battery provider 101 may include a new battery producer, and a battery provider 102 may include a used battery buyer. In this case, a plurality of batteries of the battery pool 200 may include a new battery and a used battery. For example, when the plurality of battery providers 100 are configured as the single battery requester or the plurality of battery requesters of the same type, the plurality of batteries in the battery pool 200 may include only the new battery or may include only the used battery.

For example, when the plurality of battery requesters 300 are different from each other, a battery requester 301 may include a vehicle manufacturer and/or a non-vehicle mobility manufacturer, and a battery requester 302 may include at least one of an energy storage system (ESS), a distributed power generation system (e.g., a photovoltaic power generation system), or an uninterruptible power supply system (UPS).

Overall characteristics (e.g., performance, model, state) of a battery provided by each of the plurality of battery providers 100 may be different from each other, and overall characteristics (e.g., performance, model, state) of a battery requested by each of the plurality of battery requestors 300 may be different from each other.

For example, the battery requester 301 may diversify models of a vehicle to be manufactured, and may frequently change a design of each of the models to be optimized to user needs of the vehicle. Accordingly, uncertainty of overall characteristics (e.g., performance, model, state) of a battery requested by the battery requester 301 may be large, and uncertainty of a time when the battery requester 301 actually disposes the battery in the vehicle may be large.

For example, the battery provider 101 may provide large-scale production facilities for manufacturing batteries, and design change flexibility for batteries and/or production facilities may be limited. Accordingly, overall characteristics (e.g., performance, model, state) of a battery provided by the battery provider 101 may not be easy to cope with the uncertainty of the overall characteristics (e.g., performance, model, state) of the battery requested by the battery requester 301, and a time when the battery provider 101 provides the battery may also not be easy to cope with the uncertainty of the time when the battery requester 301 actually disposes the battery in the vehicle.

The battery pool 200 may store the plurality of batteries until a temporary difference between the overall characteristics (e.g., performance, model, state) of the battery provided by the battery provider 101 and the overall characteristics (e.g., performance, model, state) of the battery requested by the battery requester 301 is reduced, and may store the plurality of batteries until a temporary difference between the time when the battery provider 101 provides the battery and the time when the battery requester 301 actually disposes the battery in the vehicle is reduced.

As characteristics (e.g., performance, model, state) of the plurality of batteries of the battery pool 200 are changed, difficulty of matching (and/or required time) between the characteristics (e.g., performance, model, state) of the battery provided by the plurality of battery providers 100 and the characteristics (e.g., performance, model, state) of the battery requested by the plurality of battery requesters 300 may increase, a time to be required may increase, and difficulty of matching (and/or required time) between the time when the plurality of battery providers 100 provide the battery and the time when the plurality of battery requesters 300 actually use the battery may increase. Since a time during which the battery pool 200 may store the plurality of batteries may be limited, a ratio of batteries to be discarded among the plurality of batteries may increase, as the difficulty of matching (and/or required time) increases.

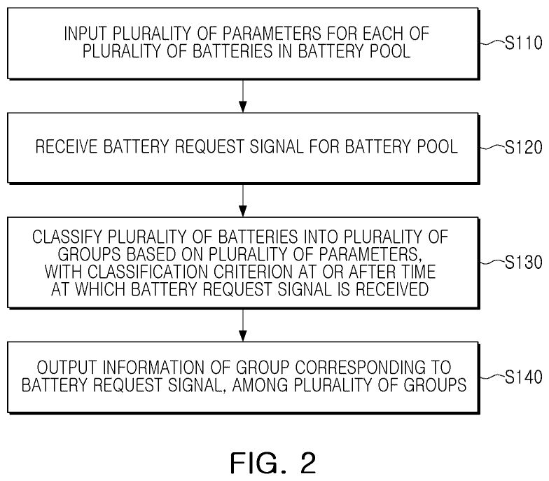

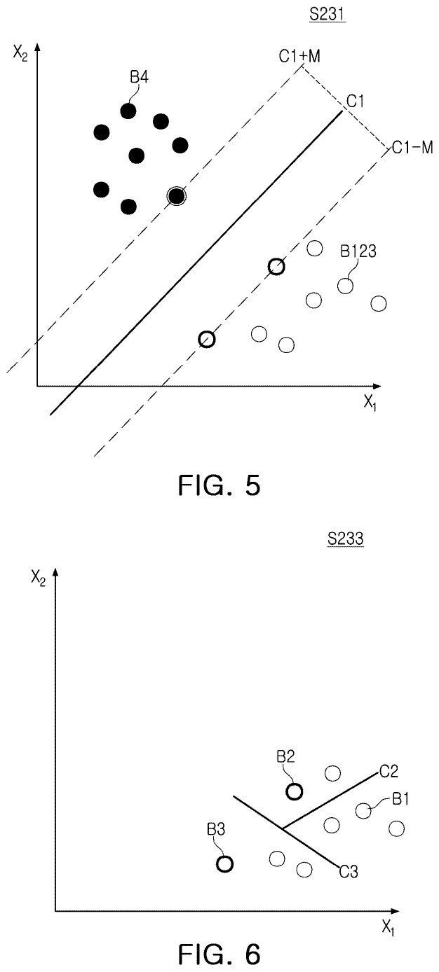

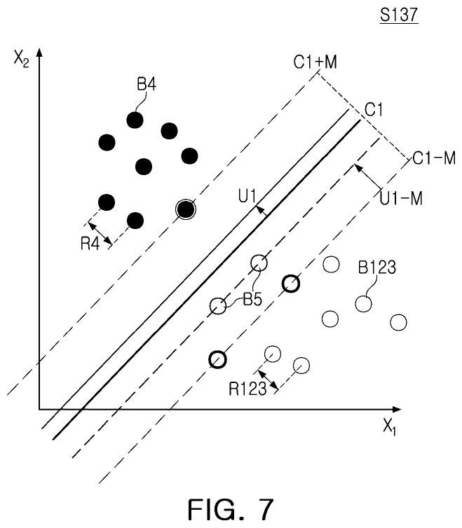

Referring to FIGS. 1 and 2, a method for controlling battery pool management, according to an embodiment of the present disclosure, may include inputting a plurality of parameters for each of a plurality of batteries in a battery pool 200 (S110); receiving a battery request signal for the battery pool 200 (S120); classifying the plurality of batteries into a plurality of groups (e.g., B4 in FIG. 5, B1 in FIG. 6, B2 in FIG. 6, B3 in FIG. 6) based on the plurality of parameters, with a classification criterion (e.g., C1 in FIG. 5, C2 in FIG. 6, C3 in FIG. 6, U1 in FIG. 7) at or after a time at which the battery request signal is received (S130); and outputting information of a group corresponding to the battery request signal, among the plurality of groups (S140). A controller 500 may execute the method for controlling battery pool management.

Accordingly, difficulty of matching (and/or required time) may be lowered, and a ratio of batteries to be discarded among the plurality of batteries of the battery pool 200 may be lowered. As the ratio of batteries to be discarded among the plurality of batteries decreases, the plurality of batteries may be more eco-friendly (e.g., decrease of environmental pollution, or increase of resource usage efficiency).

In addition, the information output by the outputting (S140) may improve battery market transparency and/or reliability, may reduce information asymmetry between a plurality of battery providers 100 and a plurality of battery requesters 300, may further activate battery transactions between the plurality of battery providers 100 and the plurality of battery requester 300, may further diversify the plurality of battery providers 100 and/or the plurality of battery requesters 300, and may further expand battery market.

An apparatus for controlling battery transaction support, according to an embodiment of the present disclosure, may include a controller 500, and the controller 500 may input a plurality of parameters for each of a plurality of batteries in a battery pool 200, may receive a battery request signal for the battery pool 200, may classify the plurality of batteries into a plurality of groups based on the plurality of parameters, with a classification criterion at or after a time at which the battery request signal is received; and may output information of a group corresponding to the battery request signal, among the plurality of groups.

For example, in the inputting (S110), the controller 500 may execute a first interface operation of inputting the plurality of parameters from at least one battery provider 101 and/or 102 of the plurality of battery providers 100. In this case, the inputting may be implemented with at least one of electrical signal transmission, wired communication, or wireless communication, and an input/output interface 505 and/or a network communication interface 506, as in FIG. 1, may execute the first interface operation.

For example, the battery provider 101 may include a manufacturing execution system (MES) entirely controlling a production facility (including a measurement facility), and the battery provider 102 may include a battery management system (e.g., enterprise resource planning system) entirely managing a used battery. The manufacturing execution system may generate a plurality of parameters for each of new batteries to be produced, and input the plurality of parameters to the controller 500 in conjunction with the production facility (including a measurement facility). The battery management system may generate a plurality of parameters for each of used batteries, and may input the plurality of parameters to the controller 500 in conjunction with the battery pool 200.

For example, in the receiving (S120), the controller 500 may execute a second interface operation of receiving the battery request signal from at least one battery requestor 301 and/or 302 of the plurality of battery requestors 300. In this case, the receiving may be implemented with at least one of electrical signal transmission, wired communication, or wireless communication, and an input/output interface 505 and/or a network communication interface 506, as in FIG. 1, may execute the second interface operation.

For example, in the outputting (S140), the controller 500 may execute e a third interface operation of outputting the information to at least one battery requestor 301 and/or 302 of the plurality of battery requestors 300. In this case, the outputting may be implemented with at least one of electrical signal transmission, wired communication, or wireless communication, and an input/output interface 505 and/or a network communication interface 506, as in FIG. 1, may execute the third interface operation.

For example, in the classifying (S130), the controller 500 may periodically optimize the classification criterion for classifying the plurality of batteries of the battery pool 200 into the plurality of groups. Configurations of a plurality of batteries of the battery pool 200 may be different from each other at different times, and optimal classification criteria for classifying the plurality of batteries into the plurality of groups may also be different from each other at different times.

For example, when the battery provider 101 improves a production facility (and/or a battery raw material) at a specific time, overall battery performance of the battery provided by the battery provider 101 may increase after a specific time, and classification criteria after the specific time (e.g., classification criteria between a high-quality group and a medium-quality group) may be higher than classification criteria before the specific time.

For example, when amounts of used batteries provided by the battery provider 102 increase from a certain time, average performance of the battery provided by the plurality of battery providers 100 may be lowered after the specific time, and the classification criteria (e.g., classification criteria between an available group and a non-available group) after the specific time may be lower than the classification criteria before the specific time.

For example, in the classifying (S130), since the controller 500 may manage a time of a classification criterion for classifying a plurality of batteries of the battery pool 200 into a plurality of groups at or after a time at which the battery request signal is received, the plurality of batteries may be flexibly classified into the plurality of groups according to current configurations of the plurality of batteries, classification accuracy/reliability may be improved, and accuracy/reliability of information output by the controller 500 may be improved in the outputting (S140).

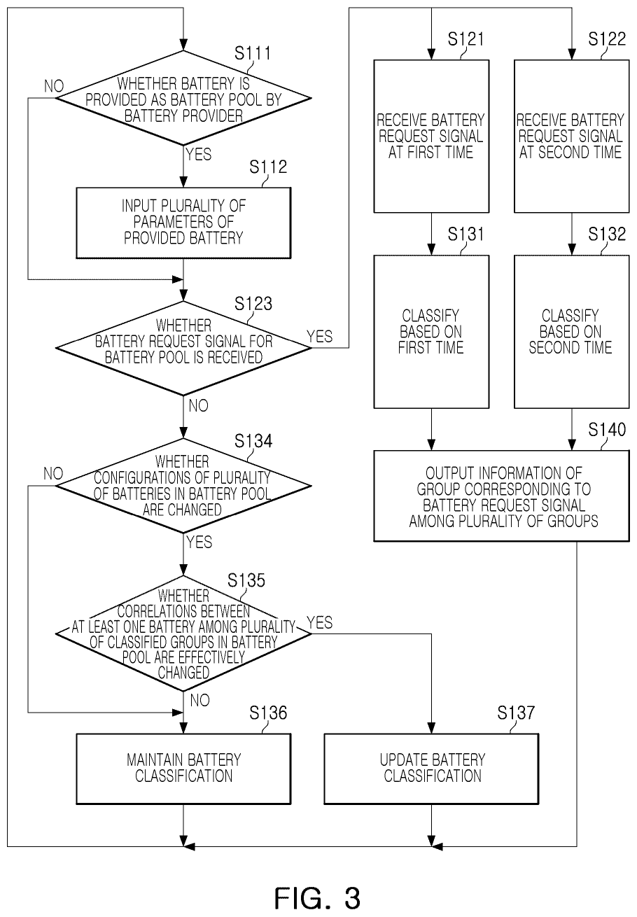

Referring to FIGS. 2, 3 and 7, in the inputting (S110), the controller 500 may update (e.g., input) a plurality of parameters X1 and X2 of a battery B5 additionally provided (S112), as configurations of a plurality of batteries B123 and B4 in the battery pool 200 are changed (B5 added) (S111).

In the classifying (S130), when configurations of a plurality of batteries in the battery pool 200 are changed (B5 added) (S134), the controller 500 may selectively update classification into the plurality of groups of batteries (S137) (e.g., classification criterion C1 may be changed to updated classification criterion U1) according to whether correlations R4 and R123 between a plurality of classified groups may be effectively changed (S135). The updating (S137) may include resetting the classification. When not, in the classifying (S130), the controller 500 may maintain battery classification (S136).

The correlations R4 and R123 between the batteries may be an average correlation between all batteries belonging to each of the plurality of groups (e.g., one side and the other side of the classification criterion C1). For example, in the classifying (S130), the controller 500 may calculate a first standard deviation of a first parameter (e.g., X1) and a second standard deviation of a second parameter (e.g., X2) of all batteries belonging to one of the groups (e.g., right lower side of the classification criterion C1, and may calculate a square root (Pythagorean theorem) of a sum of a square of the first standard deviation and a square of the second standard deviation (e.g., the right lower side of the classification criterion C1 as a reciprocal of a correlation between the batteries (e.g., B123) of one of the groups (e.g., B123).

According to the battery B5 additionally provided, both the first standard deviation of the first parameter (e.g., X1) and the second standard deviation of the second parameter (e.g., X2) of the batteries (e.g., B123) of one (e.g., the right lower side of the classification criterion C1) of the plurality of groups may increase, and the correlation may decrease. In this case, when an amount of change in the correlation is greater than a specific value or the lowered correlation is lower than the reference value, in the classifying (S130), the controller 500 may determine that at least one of the classified plurality of groups has been effectively changed.

In the receiving (S120), the controller 500 may receive a battery request signal before the updating (S112) (e.g., inputting) (e.g., first time) of the plurality of parameters X1 and X2 of the additionally provided battery B5 (S121), and may receive a battery request signal after the updating (S112) (e.g., inputting) (e.g., second time) of the plurality of parameters X1 and X2 of the additionally provided battery B5 (S122).

In the classifying (S130), the controller 500 may classify the plurality of batteries into a plurality of groups based on the plurality of parameters X1 and X2, with a classification criterion before the updating (S112) (e.g., inputting) (e.g., first time) (S131), and classify the plurality of batteries into a plurality of groups based on the plurality of parameters X1 and X2, with a classification criterion after the updating (S112) (e.g., inputting) (e.g., second time) (S132).

Accordingly, in the outputting (S140), the controller 500 may flexibly classify the plurality of batteries into a plurality of groups according to current configurations of the plurality of batteries of the battery pool 200, to accurately output reliable information of a group corresponding to the battery request signal, whether the battery request signal is received at any one of a first time or a second time (S123).

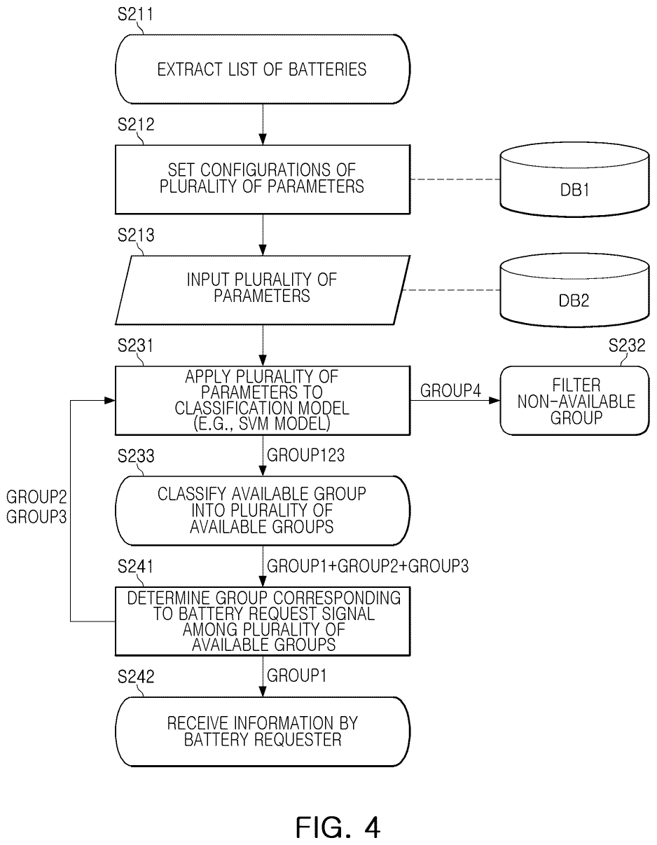

Referring to FIGS. 2, 4, 5, and 6, in the classifying (S130), the controller 500 may apply the plurality of parameters X1 and X2 to a classification model, with a classification criterion at or after a time at which the battery request signal is received (S231). For example, the controller 500 may receive and store the classification model before initial classification.

The classification model may be configured to classify a correlation (e.g., R123 and R4 in FIG. 7) between batteries of each of the plurality of groups to be higher than a reference (e.g., such that an average correlation is the highest). The classification model may include a support vector machine (SVM) model, but is not limited thereto. The classification model may be selected in consideration of a characteristic of each of the plurality of parameters, heterogeneity between the plurality of parameters, a total amount of data of the plurality of parameters, complexity of classification, calculation resources, or the like. The plurality of parameters may be composed of text data and number data, and since the text data and the number data may be advantageous to be applied to a machine learning model, the classification model may be the machine learning model. The machine learning model may include the support vector machine (SVM) model.

For example, in the classifying (S130), the controller 500 may generate N-dimensional distribution data in which each of the plurality of parameters X1 and X2 is configured as an axis. The N in the N-dimensional distribution data may be the number of the plurality of parameters X1 and X2. Thereafter, the controller 500 may arrange each of a plurality of batteries of the battery pool 200 in the N-dimensional distribution data according to the plurality of parameters X1 and X2. Thereafter, the controller 500 may generate a plurality of boundary candidates in the N-dimensional distribution data that may not overlap the plurality of batteries.

For example, the plurality of boundary candidates may be boundary lines when the number of the plurality of parameters X1 and X2 is two, boundary surfaces when the number of the plurality of parameters X1 and X2 is three, or hyperplane when the number of the plurality of parameters X1 and X2 is four or more. When the plurality of boundary candidates are linear, the boundary lines may be straight lines and the boundary surfaces may be planar surfaces, but are not limited thereto. For example, when the plurality of boundary candidates are non-linear, the boundary lines may be curved surfaces and the boundary surfaces may be curved surfaces.

For example, in the classifying (S130), the controller 500 may calculate a separation distance (M in FIG. 5) for the closest battery among the plurality of boundary candidates, and determine a boundary candidate having the longest separation distance as the classification criterion (C1 in FIG. 5).

When a plurality of parameters of the additionally provided battery B5 of FIG. 7 are further updated, the separation distance M may be shortened, and the classification criterion C1 of FIG. 5 may be changed to the updated classification criterion U1 of FIG. 7. The updated classification criterion U1 of FIG. 7 may include a reset classification criterion.

When the separation distance M is too short (e.g., when the correlation between the batteries is effectively changed), the controller 500 may determine a new classification criterion for the boundary candidate that may be different from the classification criterion (C1 in FIG. 5) among the plurality of boundary candidates.

For example, when additional batteries are intensively added to a right upper side and a lower left side of the distribution data of FIG. 5, the controller 500 may determine that the separation distance M is too short, and may determine a vertical straight line passing through a center of the distribution data of FIG. 5 as the new classification criterion.

In the classifying operation S130, the controller 500 may filter by classifying some of the plurality of batteries of the battery pool 200 into one of the plurality of groups (e.g., group 4, non-available group) (S232), and may classify a remaining battery of the plurality of batteries (e.g., group 123, available group) into a remaining group of the plurality of groups (e.g., group 1, group 2, group 3) based on the plurality of parameters X1 and X2 (S233). For example, in the classifying (S130), the controller 500 may apply the plurality of parameters X1 and X2 to the support vector machine model SVM for the filtering (S232).

For example, when a ratio of used batteries among the plurality of batteries of the battery pool 200 is high, in the classifying (S130), the controller 500 may reduce the total number of remaining batteries among the plurality of batteries by filtering some of the plurality of batteries (S232), and may reduce data throughput required for the classifying (S233). Data throughput required for the filtering (S232) may be greater than data throughput required for the classifying (S233), but the support vector machine model SVM may be a classification model, which is advantageous for increasing the filtering (S232) efficiency, and the controller 500 may use a classification model (e.g., a decision tree model), which is advantageous for increasing high-dimensional accuracy and/or speed of the classifying (S233), in the classifying (S233). Depending on a design, the controller 500 may also use the support vector machine model SVM for the classifying (S233).

For example, in the classifying (S130), the controller 500 may classify some of the plurality of batteries into a low-quality (e.g., grade C) group (e.g., group 4) through the filtering (S232), and may classify the remaining battery of the plurality of batteries into a group close to a new battery (e.g., group 1), a high-quality (e.g., grade A) group (e.g., group 2), and a medium-quality (e.g., grade B) group (e.g., group 3), through the classifying (S233).

For example, a classification criterion of the group close to a new battery (e.g., group 1) may correspond to a minimum criterion for a specification such as capacity, internal resistance, charging characteristics, or the like of the classified battery to fall within a standard range suggested by a battery producer.

For example, a classification criterion of the high-quality (e.g., grade A) group (e.g., group 2) may correspond to a minimum criterion for classifying high-quality batteries, which have some traces of use, but in excellent overall condition, close to original capacity thereof, have low internal resistance, have excellent charging and discharging characteristics, have a state of health (SOH) of 80% or more (depending on a battery model), and suitable for reuse.

For example, a classification criterion of the medium-quality (e.g., grade B) group (e.g., group 3) may correspond to a minimum criterion for classifying medium-quality batteries, which have some traces of use, lose some of original capacity thereof, have slightly higher internal resistance, have still good charging and discharging characteristics, have a state of health (SOH) of less than 80%, and suitable for use with requirements for specific standardized applications.

For example, a classification criterion of the low-quality (e.g., grade C) group (e.g., group 4) may correspond to a minimum criterion for classifying low-quality batteries, which have significant traces of use or significantly reduced capacity, have high internal resistance, have low charging and discharging characteristics, have irregular charging and discharging characteristics, have a state of health (SOH) of less than 50% (depending on a battery model), and suitable for small projects or auxiliary use for recycling.

A difference between the plurality of groups may be overall quality of the battery, but is not limited thereto. For example, some of the plurality of parameters may not be directly related to quality of the battery, and the plurality of groups may be classified according to some of the parameters. For example, plurality of battery requesters 300 may determine importance of some of the parameters differently, and a battery requester which determines the importance of some of the parameters low (or high) may check information of the group with the parameters and obtain the battery of the group.

For example, when some of the parameters are external characteristics of the battery, a battery requester which uses the battery under a harsh (or stable) environment, among the plurality of battery requesters 300, may check information of a group in which some of the parameters are high (or low), and may obtain batteries of the group.

In the receiving (S120) of FIG. 2, the controller 500 may receive a battery request signal including subject data of at least one battery requestor 301 and/or 302 of the plurality of battery requestors 300. In the outputting (S140), the controller 500 may determine a group corresponding to the subject data among the plurality of groups (S241), and may output information corresponding to the determined group.

For example, information corresponding to the determined group may include information introducing the batteries classified into the determined group to the battery requester (e.g., battery specification information, quality information, price information), and may be implemented as information guiding the battery requester to obtain the batteries (e.g., information on how to obtain them from any of the plurality of battery providers).

For example, the subject data may include importance data indicating how important each of the plurality of parameters is determined by the battery requester. The controller 500 may determine a group of which parameter is high (or low), corresponding to a parameter of which importance is high (or low), in the importance data. The battery requester may receive information corresponding to the determined group (S242).

For example, the subject data may include identification data of each of the plurality of battery requestors 300, and may include importance data bound to each of a plurality of identification data. For example, the subject data may be determined according to characteristics (e.g., battery usage, timing, or the like) of each of the plurality of battery requestors 300.

For example, in the inputting (S110 in FIG. 2), the controller 500 may extract a list of the plurality of batteries of the battery pool 200 (S211), may set configurations of the plurality of parameters X1 and X2, based on first database DB1 (S212), and may input the plurality of parameters X1 and X2 of plurality of batteries to the classification model, based on second database DB2 (S213).

For example, the plurality of parameters X1 and X2 may include at least two of a standard parameter for a standard of the plurality of batteries, a quality parameter for quality of the plurality of batteries, a storage parameter for storage of the plurality of batteries, and a measurement parameter corresponding to a measurement result for the plurality of batteries.

For example, the first database DB1 may include 25 parameters of Table 1 below, but is not limited thereto. The controller 500 may set configurations of the plurality of parameters X1 and X2 by selecting parameters to be input to a classification model, among the 25 parameters (S212). Thereafter, the controller 500 may select parameters selected from the second database DB2 input by the plurality of battery providers 100, and may input the selected parameters to the classification model (S213).

TABLE 1

| No. | Type of Parameter | Name of Parameter | |
|---|---|---|---|
| 1 | Standard Parameter | Type of Battery | Pouch, Prismatic, |
| | | | Cylindrical, Etc. |
| 2 | Standard Parameter | Name of Model | Battery Model |
| 3 | Standard Parameter | Production Site | Nation of producing Battery |
| 4 | Storage Parameter | Production Date | OCV(open circuit voltage) |
| | | | Measurement Date |
| 5 | Standard Parameter | Producer | Battery Producer |
| 6 | Measurement | OCV | OCV(open circuit voltage) |
| | Parameter | | Measured Value |
| 7 | Measurement | SDR | SDR(self-discharge rate) |
| | Parameter | | Calculated Value |
| 8 | Measurement | Insulation Resistance | Battery Insulation Resistance |
| | Parameter | | Measured Value |
| 9 | Quality Parameter | Leakage occurs or not | Leakage occurs or not on |
| | | | Battery Cell Exterior |
| 10 | Measurement | Battery Capacity | Battery Reference Capacity |
| | Parameter | | |
| 11 | Storage Parameter | Package Date | Battery Production Facility |
| | | | Package Date |
| 12 | Storage Parameter | Number of Holding Days | Number of Holding Days after |
| | | | obtaining Battery Pool |
| 13 | Quality Parameter | Foreign Substance | Foreign Substance is present |
| | | | or not on Battery Exterior |
| 14 | Quality Parameter | Scratch | Scratch is present or not |
| | | | on Battery Exterior |
| 15 | Quality Parameter | Dent | Dent is present or not on |
| | | | Battery Exterior |
| 16 | Quality Parameter | Pressure Mark | Pressure Mark is present |
| | | | or not on Battery Exterior |
| 17 | Quality Parameter | Folding of Separator | Folding of Separator occurs |
| | | | or not on Battery Exterior |
| 18 | Quality Parameter | Contamination | Contamination occurs or not |
| | | | on Battery Appearance |
| 19 | Quality Parameter | Tap Damage | Tap Damage occurs or not on |
| | | | Battery Cell |
| 20 | Quality Parameter | Electrode Damage | Electrode Damage occurs or |
| | | | not on Battery Cell |
| 21 | Quality Parameter | Previous Product | Determination of Battery |
| | | State Value | Defect Cause |
| 22 | Measurement | Capacity Measurement | Battery Capacity Measurement |
| | Parameter | | Value |
| 23 | Standard Parameter | Usage or not | Usage or not of Battery |
| 24 | Storage Parameter | Storage is performed | Battery Cell Storage |
| | | or not under Constant | Conditions are satisfied |
| | | Temperature and Humidity | or not |
| 25 | Standard Parameter | Cell Size | Length and Width Sizes of |
| | | | Battery Cell |

Referring to FIG. 1, the controller 500 may be implemented as a computing system including at least one processor 501, a computer-readable storage medium 502, and a communication bus 503. The storage medium 502 may record at least one program including instructions for executing a method for controlling battery pool management according to t an embodiment of the present disclosure. The communication bus 503 may interconnect other various components of the controller 500, including the processor 501 and the computer-readable storage medium 502.

The processor 501 may cause the controller 500 to operate according to the example embodiment. For example, the processor 501 may execute at least one program stored in the computer-readable storage medium 502. The at least one program may include at least one computer-executable instruction, and the computer-executable instruction may be configured to cause the controller 500 to perform an operation according to example embodiments when executed by the processor 501.

The computer-readable storage medium 502 may be configured to store the computer-executable instruction or a program code, program data, and/or other suitable forms of information. A program 502a stored in the computer-readable storage medium 502 may include a set of instructions executable by the processor 501. In an embodiment, the computer-readable storage medium 502 may be a memory (volatile memory, non-volatile memory, such as random access memory, or an appropriate combination thereof), at least one magnetic disk storage device, at least one optical disk storage device, at least one flash memory device, or other form of storage medium accessible by the controller 500 and capable of storing desired information, or a suitable combination thereof.

The controller 500 may also include at least one input/output interface 505 and at least one network communication interface 506, providing interfaces for at least one input/output device 504. The input/output interface 505 and the network communication interface 506 may be connected to the communication bus 503. A network may be a cellular network, such as global system for mobile communications (GSM), enhanced data rates for GSM evolution (EDGE), general packet radio service (GPRS), code division multiple access (CDMA), time division-CDMA (TD-CDMA), universal mobile telecommunications system (UMTS), long term evolution (LTE), 5G, Wi-Fi, or any other cellular network, and may be implemented by Ethernet, media oriented systems transport (MOST), Flexray, controller area network (CAN), local interconnect network (LIN), Internet, Bluetooth®, near field communication (NFC), Zigbee®, Radio Frequency, or the like.

The input/output device 504 may be connected to other components of the controller 500 through the input/output interface 505. The exemplary input/output device 504 may include a pointing device (such as a mouse or track pad), a keyboard, a touch input device (such as a touch pad or a touch screen), a voice or sound input device, an input device such as various types of sensor devices and/or a photographing device, and/or an output device such as a display device, a printer, a speaker and/or a network card. The example input/output device 504 may be a component constituting the controller 500, and may be included in the controller 500, or may be connected to the controller 500 as a separate device distinct from the controller 500.

An embodiment of the present disclosure may include a program for performing the methods described in the present specification on a computer, and a computer-readable recording medium including the program. The computer-readable recording medium may include a program command, a local data file, a local data structure, or the like alone or in combination. The media may be those specifically designed and configured for the present disclosure, or may be commonly used in the field of computer software. Examples of computer-readable recording media include magnetic media such as hard disks, floppy disks, and magnetic tapes, optical recording media such as CD-ROMs and DVDs, and hardware devices specifically configured to store and perform program instructions such as ROMs, RAMs, flash memories, or the like. Examples of the program may include advanced language codes that may be executed by a computer using an interpreter or the like, as well as machine language codes such as those made by a compiler.

Those of ordinary skill in the art to which the present disclosure pertains will understand that the present disclosure may be practiced in other specific forms without changing its technical idea or essential features. Therefore, it should be understood that the embodiments described above may be exemplary and not limited in all respects. The scope of the present disclosure should be expressed by the scope of the patent claim to be described below rather than the detailed description, and all changes or modifications derived from the meaning and scope of the patent claim and the equivalent concept should be interpreted as being included in the scope of the present disclosure.

A method and storage medium for controlling battery pool management, and an apparatus for controlling battery transaction support, according to an embodiment of the present disclosure, may improve classification accuracy/reliability of a plurality of batteries of a battery pool.

For example, matching difficulty (and/or required time) between a battery provider and a battery requester may be lowered, and a ratio of batteries to be discarded, among a plurality of batteries of a battery pool, may be lowered. As a ratio of batteries to be discarded among a plurality of batteries decreases, the plurality of batteries may be more eco-friendly (e.g., decrease of environmental pollution, or increase of resource usage efficiency).

For example, battery market transparency and/or reliability may be improved, information asymmetry between a battery provider and a battery requester may be reduced, battery transactions may be further activated, battery providers and battery requestors in a battery market may be more diversified, and a size of the battery market may increase.

Only specific examples of implementations of certain embodiments may be described. Variations, improvements and enhancements of the disclosed embodiments and other embodiments may be made based on the disclosure of this patent document.

What is claimed is:

1. A method for controlling battery pool management, comprising:
inputting a plurality of parameters for each of a plurality of batteries in a battery pool;
receiving a battery request signal for the battery pool;
classifying the plurality of batteries into a plurality of groups based on the plurality of parameters, with a classification criterion at or after a time at which the battery request signal is received; and
outputting information of a group corresponding to the battery request signal, among the plurality of groups.

2. The method of claim 1, wherein the inputting includes updating the plurality of parameters, as configurations of the plurality of batteries in the battery pool are changed.

3. The method of claim 2, wherein the receiving includes receiving a battery request signal before the updating the plurality of parameters, and receiving a battery request signal after the updating the plurality of parameters,
wherein the classifying includes classifying the plurality of batteries into a plurality of groups based on the plurality of parameters, with a classification criterion before the updating the plurality of parameters, and
wherein the classifying includes classifying the plurality of batteries into a plurality of groups based on the plurality of parameters, with a classification criterion after the updating the plurality of parameters.

4. The method of claim 2, wherein the classifying includes updating classification of the plurality of batteries into a plurality of groups, as configurations of the plurality of batteries in the battery pool are changed, optionally according to whether correlation between at least one of the classified groups is effectively changed.

5. The method of claim 1, wherein the classifying includes applying the plurality of parameters to a classification model, with a classification criterion at or after a time at which the battery request signal is received, and
wherein the classification model includes a support vector machine model.

6. The method of claim 5, wherein the classifying includes filtering by classifying some of the plurality of batteries into one of the plurality of groups, and classifying a remaining battery of the plurality of batteries into a remaining group of the plurality of groups based on the plurality of parameters, and
wherein the classifying includes applying the plurality of parameters to the support vector machine model for the filtering.

7. The method of claim 1, wherein the classifying includes applying the plurality of parameters to a classification model, with a classification criterion at or after a time at which the battery request signal is received, and
wherein the classification model is configured to classify correlation between batteries of each of the plurality of groups to be higher than a reference.

8. The method of claim 1, wherein the plurality of parameters include at least two of a standard parameter for a standard of the plurality of batteries, a quality parameter for quality of the plurality of batteries, a storage parameter for storage of the plurality of batteries, and a measurement parameter corresponding to a measurement result for the plurality of batteries.

9. The method of claim 1, wherein the plurality of batteries include a new battery and a used battery.

10. The method of claim 1, wherein the receiving includes receiving the battery request signal including subject data of at least one among a plurality of battery requestors, and
wherein the outputting includes outputting information of a group corresponding to the subject data among the plurality of groups.

11. A storage medium in which at least one program including instructions for executing the method of claim 1 is recorded.

12. An apparatus for controlling battery transaction support, comprising:
a controller inputting a plurality of parameters for each of a plurality of batteries in a battery pool, receiving a battery request signal for the battery pool, classifying the plurality of batteries into a plurality of groups based on the plurality of parameters, with a classification criterion at or after a time at which the battery request signal is received, and outputting information of a group corresponding to the battery request signal, among the plurality of groups,
wherein the controller executes at least one of:
a first interface operation of inputting the plurality of parameters from at least one of a plurality of battery providers;
a second interface operation of receiving the battery request signal from at least one of a plurality of battery requesters; or
a third interface operation of outputting the information to at least one of the plurality of battery requestors.

13. The apparatus of claim 12, wherein the controller applies the plurality of parameters to a classification model, with a classification criterion at or after a time at which the battery request signal is received, and
wherein the classification model includes a support vector machine model.

14. The apparatus of claim 13, wherein the controller updates the plurality of parameters, as at least one of the plurality of battery providers provides a battery to the battery pool.

15. The apparatus of claim 12, wherein the plurality of parameters include at least two of a standard parameter for a standard of the plurality of batteries, a quality parameter for quality of the plurality of batteries, a storage parameter for storage of the plurality of batteries, and a measurement parameter corresponding to a measurement result for the plurality of batteries, and
wherein the plurality of batteries include a new battery and a used battery.
